(19) United States
(12) Patent Application Publication
(10) Pub. No.: US 2013/0075374 A1
(43) Pub. Date: Mar. 28, 2013

(54) MEMBER SEPARATION APPARATUS AND MEMBER SEPARATION METHOD

(71) Applicants: Satoshi MITSUGI, Kanagawa-ken (JP); Hiroshi Katsuno, Tokyo (JP)

(72) Inventors: Satoshi MITSUGI, Kanagawa-ken (JP); Hiroshi Katsuno, Tokyo (JP)

(73) Assignee: Kabushiki Kaisha Toshiba, Tokyo (JP)

(21) Appl. No.: 13/404,698

(22) Filed: Feb. 24, 2012

(30) Foreign Application Priority Data
Sep. 26, 2011 (JP) 2011-208747

(51) Int. Cl. B23K 26/00

(52) U.S. Cl. 219/121.61; 219/121.6; 219/121.85

(57) ABSTRACT

According to one embodiment, a member separation apparatus includes a stage and a light source. The stage is configured to mount a workpiece. The workpiece includes a first member and a second member. The first member is transmissive to light in a wavelength region. The wavelength region includes a first wavelength. The second member contacts with the first member. The second member has a higher absorptance for light in the wavelength region than the first member. The light source generates laser light and irradiates the workpiece with the laser light. The laser light contains a component of the first wavelength and a component of a second wavelength. The second wavelength includes the wavelength region different from the first wavelength.

### CROSS-REFERENCE TO RELATED APPLICATIONS

This application is based upon and claims the benefit of priority from the prior Japanese Patent Application No. 2011-208747, filed on Sep. 26, 2011; the entire contents of which are incorporated herein by reference.

### FIELD

Embodiments described herein relate generally to a member separation apparatus and member separation method.

### BACKGROUND

For instance, in manufacturing a semiconductor light emitting device based on gallium nitride (GaN), a GaN-based crystal is grown on a sapphire substrate to form a device section. Subsequently, the interface between the sapphire substrate and the device section is irradiated with laser light to separate them. In such member separation based on laser irradiation, further improvement in productivity is desired.

### BRIEF DESCRIPTION OF THE DRAWINGS

FIG. 1 is a schematic view illustrating the configuration of a member separation apparatus;

FIGS. 2A to 2C are schematic sectional views illustrating the overview of a member separation method;

FIGS. 3A and 3B are schematic views describing the interference of laser light;

FIGS. 4A and 4B are schematic views showing the interference of multimode laser light;

FIGS. 5A and 5B illustrate calculation results of the contrast ratio due;

FIGS. 6 and 7 show the normalized one of the contrast ratio;

FIG. 8 is a schematic view illustrating the configuration of a member separation apparatus;

FIG. 9 is a schematic perspective view describing a member separation method;

FIG. 10 is a schematic sectional view describing the member separation method;

FIG. 11 is a schematic sectional view illustrating an uneven portion;

FIG. 12 shows a calculation example of the relationship between the interface reflectance and the contrast ratio of laser light; and

FIGS. 13A to 13H are schematic views illustrating the wavelength of laser light.

### DETAILED DESCRIPTION

In general, according to one embodiment, a member separation apparatus includes a stage and a light source. The stage is configured to mount a workpiece. The workpiece includes a first member and a second member. The first member is transmissive to light in a wavelength region. The wavelength region includes a first wavelength. The second member contacts with the first member. The second member has a higher absorptance for light in the wavelength region than the first member. The light source generates laser light and irradiates the workpiece with the laser light. The laser light contains a component of the first wavelength and a component of a second wavelength. The second wavelength includes the wavelength region different from the first wavelength.

Embodiments of the invention will now be described with reference to the drawings.

The drawings are schematic or conceptual. The relationship between the thickness and the width of each portion, and the size ratio between the portions, for instance, are not necessarily identical to those in reality. Furthermore, the same portion may be shown with different dimensions or ratios depending on the figures.

In the present specification and the drawings, components similar to those described previously with reference to earlier figures are labeled with like reference numerals, and the detailed description thereof is omitted appropriately.

### First Embodiment

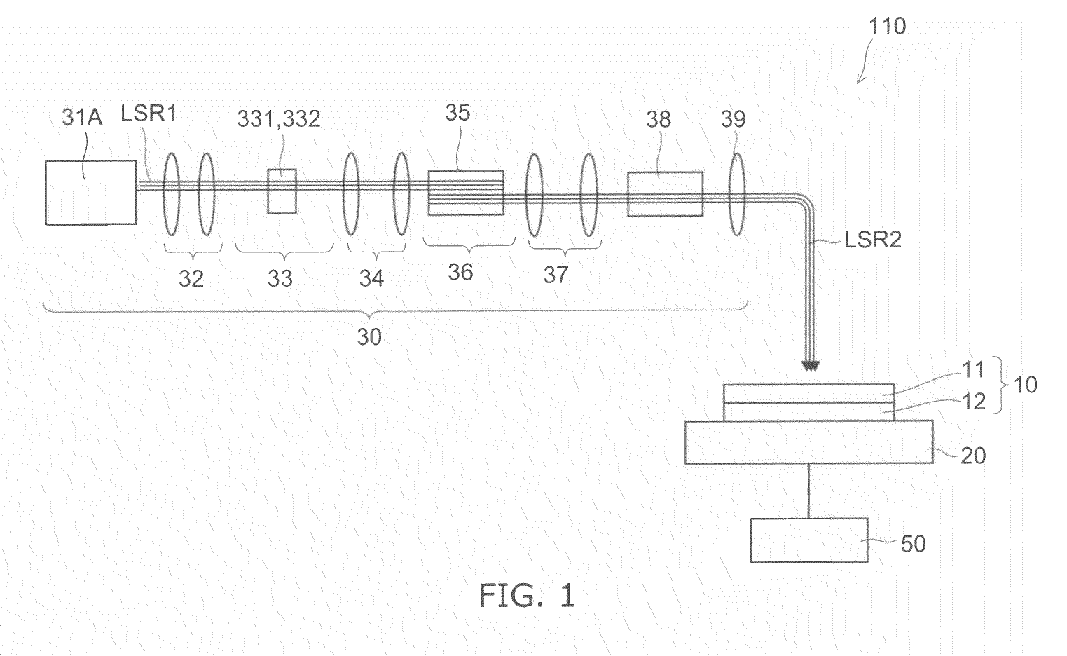

FIG. 1 is a schematic view illustrating the configuration of a member separation apparatus according to a first embodiment.

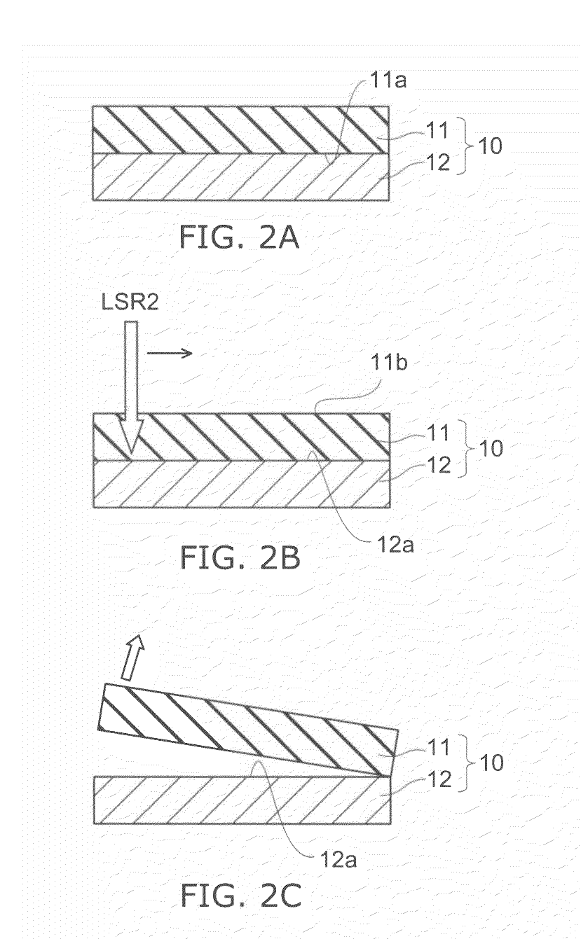

FIGS. 2A to 2C are schematic sectional views illustrating the overview of a member separation method.

As shown in FIG. 1, the member separation apparatus 110 according to the embodiment includes a stage 20 and a light source 30.

On the stage 20, a workpiece 10 is mounted. The stage 20 is a jig for e.g. fixing the workpiece 10 in the mounted state. The workpiece 10 includes a first member 11 and a second member 12 in contact with the first member 11. The first member 11 is transmissive to a wavelength region including light of a first wavelength. The second member 12 is in contact with the first member 11. The absorptance of the second member 12 for light in the wavelength region is higher than the absorptance of the first member 11 for light in the wavelength region.

The light source 30 generates laser light LSR2 including a component of the first wavelength and a component of a second wavelength. The component of the first wavelength is a component of laser light having a peak at the first wavelength. The component of the second wavelength is a component of laser light having a peak at the second wavelength. The light source 30 generates laser light LSR2 including a peak of the first wavelength and a peak of the second wavelength different from the first wavelength.

The intensity of laser light having a peak at the second wavelength is e.g. 1/10 or more of the intensity of laser light having a peak at the first wavelength. These peaks are peaks of intensity in stimulated emission light, which is laser light, and do not include peaks of spontaneous emission light.

The light source 30 irradiates the workpiece 10 on the stage 20 with the generated laser light LSR2.

With reference to FIGS. 2A to 2C, the member separation method according to the embodiment is described.

The member separation method according to the embodiment is a method for generating laser light LSR2, irradiating the workpiece 10 with the laser light LSR2, and separating the first member 11 from the second member 12.

In the embodiment, separation includes not only separating the first member 11 from the second member 12, but also separating the second member 12 from the first member.

As shown in FIG. 2A, the workpiece 10 subjected to separation includes a first member 11 and a second member 12. For instance, the first member 11 is a growth substrate, and the second member 12 is a stacked structure crystal-grown on the first major surface 11a of the first member 11. The first member 11 is e.g. a sapphire substrate. The second member 12 is e.g. a semiconductor light emitting device including a GaN stacked structure.

The workpiece 10 may include a support substrate, not shown. The support substrate is provided on the opposite side of the second member 12 from the first member 11. The support substrate serves as a member for supporting the second member 12 after the first member 11 is separated from the second member 12. The support substrate may have a function as an electrode.

As shown in FIG. 2B, the first member 11 has a second major surface 11b on the opposite side from the first major surface 11a. The laser light LSR2 is applied from the second major surface 11b side to the workpiece 10.

The first member 11 is transmissive to light of the first wavelength. The absorptance of the second member 12 for light of the first wavelength is higher than the absorptance of the first member 11 for light of the first wavelength.

The center wavelength of the laser light LSR2 is set to the first wavelength. The laser light LSR2 applied from the second major surface 11b side toward the workpiece 10 is transmitted through the first member 11 to the boundary surface 12a with the first member 11 of the second member 12.

The second member 12 absorbs the laser light LSR2. The boundary surface 12a with the first member 11 of the second member 12 is heated by absorption of the laser light LSR2. For instance, in the second member 12 including GaN, the GaN component reacts in accordance with e.g. the following formula.

GaN→Ga+½N₂↑

As a result, GaN near the boundary surface 12a undergoes at least one of melting, modification, and decomposition. As shown in FIG. 2C, the first member 11 is separated from the second member 12.

In the embodiment, the separation of the workpiece 10 by laser light irradiation as described above is performed by using laser light LSR2. The laser light LSR2 includes a peak of the first wavelength and a peak of the second wavelength different from the first wavelength. For instance, the laser light LSR2 includes multimode laser light. The multimode laser light LSR2 includes laser light lased in a plurality of longitudinal modes.

The member separation apparatus 110 according to the embodiment is an apparatus for separating the workpiece 10 by irradiation with such laser light LSR2.

The laser light components with different wavelengths included in the laser light LSR2 are transmitted through the first member 11 and form different interference patterns inside the first member 11. By superposition of the interference patterns formed for a plurality of wavelengths, the magnitude of the interference pattern is decreased. This suppresses heating irregularities due to the interference pattern of the laser light LSR2 and ensures that the first member 11 can be uniformly separated from the second member 12.

In the member separation apparatus 110 according to the embodiment, the light source 30 includes a laser source 31A. The lasing wavelength of laser light LSR1 generated from the laser source 31A is 200 nanometers (nm) or more and 2000 nm or less.

The laser light LSR1 having a lasing wavelength of less than 200 nm is vacuum ultraviolet radiation. In this case, absorption loss by air is non-negligible. The laser light LSR1 having a lasing wavelength exceeding 2000 nm incurs the decrease of heating efficiency and the decrease of processing accuracy. The reason for this is as follows. The thickness of melting at the junction interface between the members 11 and 12 is approximately the penetration distance of laser light in the second member 12. For a longer wavelength, the penetration distance is lengthened, or the interface reflectance is increased. Furthermore, to obtain harmonics (e.g., tenth harmonic); the wavelength conversion efficiency is significantly decreased. Hence, there is little advantage in purposely using long-wavelength light exceeding 2000 nm.

As an example, the peak wavelength of the laser light LSR1 generated from the laser source 31A is preferably in the range of 200 nm or more and 1600 nm or less. For instance, a KrF excimer laser having a lasing wavelength of 246 nm, a YAG (yttrium aluminum garnet) laser having a lasing wavelength of 1064 nm, and a Nd:YVO₄ laser can be used. The laser light LSR1 is e.g. multimode laser light. The laser source 31A is lased in multiple modes and emits laser light LSR1 including a plurality of wavelengths. The multimode laser light LSR1 includes laser light lased in a plurality of longitudinal modes.

Besides the laser source 31A, the light source 30 includes e.g. a first expander 32, a first collimator 33, a reducer 34, a second collimator 36, and a second expander 37. The first expander 32 expands the beam diameter of the laser light LSR1.

The first collimator 33 e.g. collimates the laser light LSR1 having the expanded beam diameter. The first collimator 33 includes e.g. an attenuator 331 and a wave plate 332. The reducer 34 reduces the beam diameter of the laser light LSR1 collimated in the first collimator 33.

The second collimator 36 e.g. collimates the laser light LSR1 having the reduced beam diameter. The second collimator 36 is provided with a wavelength conversion element as necessary. The wavelength conversion element 35 converts the wavelength of the laser light LSR1 generated from the laser source 31A to generate a component of the first wavelength and a component of the second wavelength. The wavelength conversion element 35 converts the center wavelength of the laser light LSR1 to the first wavelength. In the embodiment, the wavelength conversion element 35 multiplies the center wavelength of the laser light LSR1 by e.g. 1/n (n is an integer of 2 or more).

The second expander 37 expands the beam diameter of the laser light LSR2 wavelength-converted in the wavelength conversion element 35.

The light source 30 includes e.g. a coaxial optical section 38 and an objective lens 39. The coaxial optical section 38 is coaxial with the optical path of the laser light LSR2. The coaxial optical section 38 is used to observe the irradiation position of the laser light LSR2.

The objective lens 39 aligns the focus of the laser light LSR2 with the workpiece 10 on the stage 20. The workpiece 10 is irradiated with the laser light LSR2 having a plurality of peak wavelengths. The center wavelength of the laser light LSR2 is the first wavelength. Hence, the laser light LSR2 is transmitted through the first member 11 of the workpiece 10 and absorbed in the second member 12. Furthermore, because the laser light LSR2 has a plurality of peak wavelengths, the magnitude of the interference pattern of the laser light LSR2 in the first member 11 is decreased. Hence, heating of the workpiece 10 by the laser light LSR2 is made uniform. This ensures that the first member 11 is uniformly separated from the second member 12.

The member separation apparatus 110 according to the embodiment includes a controller 50 for controlling the relative position of the workpiece 10 mounted on the stage 20 and the irradiation position of the laser light LSR2. For instance, in this example, the stage 20 is configured to be movable along at least two axes (two orthogonal axes along the surface for mounting the workpiece 10). The controller 50 controls the position of the stage 20 along at least two axes. Alternatively, the position of the stage 20 along at least one axis may be fixed, and the controller 50 may control the irradiation position of the laser light LSR2. Furthermore, the controller 50 may include the function of controlling the irradiation time of the laser light LSR2. For instance, the controller 50 may control the laser source 31A to perform e.g. intermittent irradiation or continuous irradiation with the laser light LSR2.

In the separation of the workpiece 10 by laser light irradiation, separation failure may occur. The present inventor has found that this failure is caused by nonuniform heating of the workpiece 10 due to the interference of laser light.

The surface of the first member 11 transmitting laser light includes a significant uneven structure. Furthermore, the first member 11 has a thickness of 100 micrometers (μm) or more. Hence, it can be expected that the interference effect due to multiple reflection in the first member 11 is suppressed by the effect of scattering and thickness.

However, the spot diameter of the laser light used to separate the workpiece 10 is e.g. approximately 20 μm or more and 50 μm or less. This is sufficiently larger than the unevenness size of the surface of the first member 11. If the thickness of the first member 11 is thin, scattering enough to suppress the interference in the first member 11 is less likely to occur. Furthermore, the spectrum line width of laser light is sufficiently narrow. If the thickness of the first member 11 is e.g. approximately 100-500 μm, suppression of interference by the slight difference in the wavelength of laser light can hardly be expected. Furthermore, the boundary surface 12a between the first member 11 and the second member 12 has high absorption in the wavelength band of laser light. Hence, the reflectance of the boundary surface 12a is also high. Thus, the influence of multiple reflection in the first member 11 may be increased to an unacceptable level.

As a result, in the case where the uniformity of the thickness of the first member 11 is insufficient, the degree of heating is made nonuniform in the plane by the interference of laser light. If the contrast ratio of the heating is larger than the ratio of the upper limit to the lower limit of the window of the condition for separating these members, normal separation is difficult irrespective of any adjustment for laser output. Furthermore, even in the case where the contrast ratio of heating is smaller than the above ratio of the upper limit to the lower limit of the window, if the contrast ratio of heating is non-negligible, it greatly affects the yield of the separation process. That is, there is a possibility that separation can be reliably performed in some portions and cannot be performed in other portions. This decreases the productivity.

The embodiment has been configured to address the problem newly found as described above.

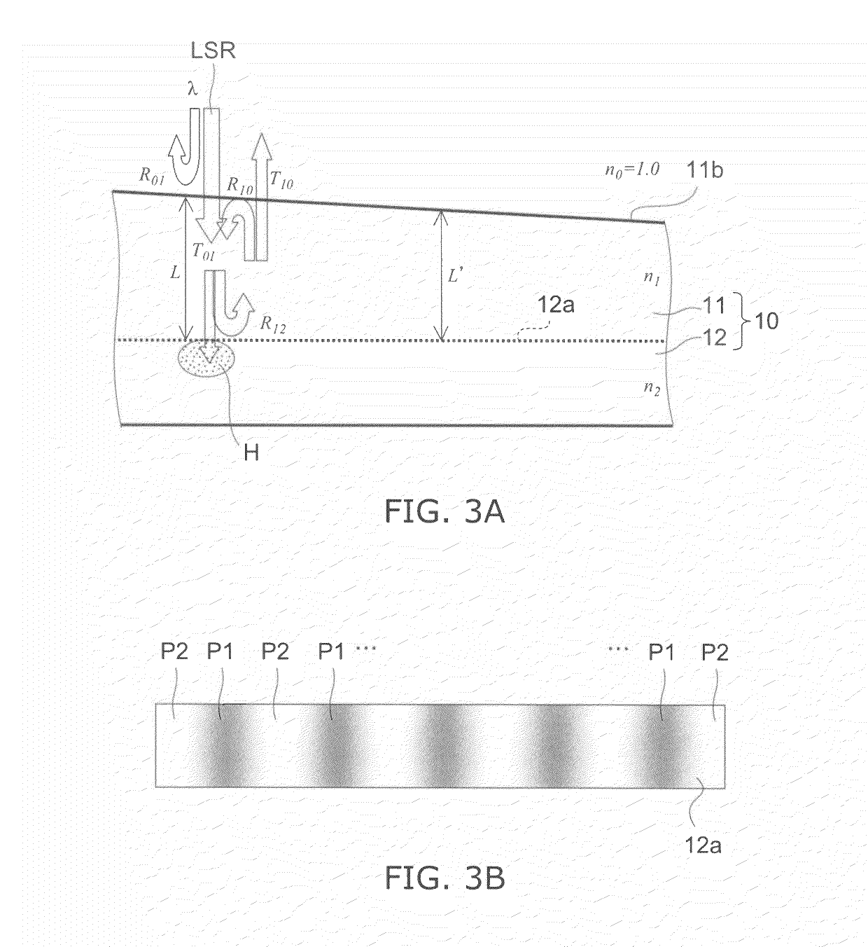

FIGS. 3A and 3B are schematic views describing the interference of laser light.

FIG. 3A is a schematic sectional view of the workpiece. FIG. 3B is a schematic view showing the light intensity at the boundary surface 12a of FIG. 3A. The portion H shown in FIG. 3A is a portion heated by laser light. In FIG. 3B, the portion P1 is a portion with strong light, and the portion P2 is a portion with weak light.

The symbols used in the following description are defined as follows.

L is the thickness of the first member 11.

nₓ is the refractive index of medium x. For instance, n₀ is the refractive index of the outside. n₁ is the refractive index of the first member 11. n₂ is the refractive index of the second member 12.

r_{xy} is the electric field amplitude reflectance for light incident on medium x and medium y. r_{xy} is given by (nₓ−n_{y})/(nₓ+n_{y}).

Rₓ is the power reflectance at the interface between medium x and medium x−1. Rₓ is given by (r_{x,x-1})² or (r_{x-1,x})².

t_{xy} is the electric field amplitude reflectance for light traveling from medium x to medium y. t_{xy} is given by 2nₓ/(nₓ+n_{y})=1+r_{xy}.

λ is the center wavelength of laser light.

Δλ is the mode spacing of laser light.

λ_{w} is the gain bandwidth under the assumption that the spectrum distribution of laser light is gaussian.

m is the longitudinal mode number of laser light. The center wavelength corresponds to m=0.

M is the longitudinal mode range of laser light, −M≦m≦+M.

Here, it is assumed that absorption of laser light in the first member 11 is negligible. As shown in FIG. 3A, the thickness L of the first member 11 varies with position. Thus, if the proportion (Rₜₒₜₐₗ) of laser light ultimately reflected by multiple reflection in the first member 11 is calculated, the proportion of applied laser light contributing to heating (heating intensity, Pₕₑₐₜ) can be expressed as Pₕₑₐₜ=1−Rₜₒₜₐₗ. Pₕₑₐₜ can be represented by the following Equation 1.

[symbol]

[Equation 1]

Here, the maximum of the contrast ratio (meaning highest peak to lowest valley ratio) due to the interference of laser light is denoted by η. η can be represented by the following Equation 2.

[symbol]

[Equation 2]

The heating intensity Pₕₑₐₜ is maximized or minimized as the first member 11 is varied by ΔL=λ/4n.

As an example, consider the case where the first member 11 is a sapphire substrate, and the second member 12 is a stacked structure (semiconductor crystal growth layer) of GaN-based semiconductor.

The center wavelength (λ) of laser light is set to 266 nanometers (nm). The refractive index (n₁) of the first member 11 is set to 1.8. The thickness (L) of the first member 11 is set to 200 mm. The reflectance at the boundary surface 12a between the first member 11 and the second member 12 (hereinafter simply referred to as “interface reflectance”) (R₂) is set to 20%. Then, ΔL=37 nm is obtained. For a typical substrate size, this value is an unavoidable error because of nonuniformity in thickness due to substrate warpage and polishing irregularities. Hence, it is considered that the maximum contrast ratio of laser light exists in the same first member 11 (sapphire substrate). The maximum contrast ratio (η) in this case is 1.67.

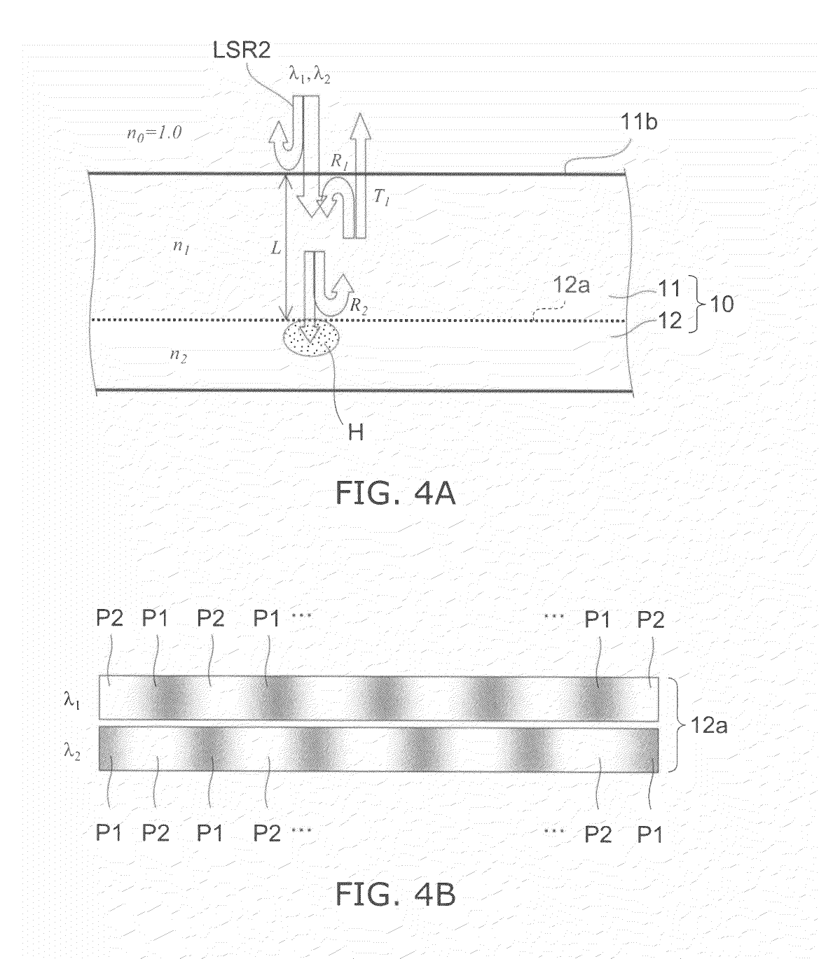

FIGS. 4A and 4B are schematic views showing the interference of multimode laser light.

FIG. 4A is a schematic sectional view of the workpiece. FIG. 4B is a schematic view showing the light intensity at the boundary surface 12a of FIG. 4A.

As shown in FIGS. 4A and 4B, in multimode laser light, the interference for each of the wavelengths λ₁ and λ₂ is similar to that shown in FIGS. 3A and 3B.

On the other hand, for the wavelengths λ₁ and λ₂, the position where the peak/valley position of the interference appears is different. Thus, because the peak/valley position of the interference is different for the wavelengths λ₁ and λ₂, the variations of the interferences cancel out each other. Hence, in multimode laser light (e.g., laser light LSR2), nonuniform heating at the boundary surface 12a between the first member 11 and the second member 12 due to the interference is suppressed. Thus, the first member 11 and the second member 12 can be reliably separated from each other.

Next, the heating intensity (Pₕₑₐₜ) in the multimode case is described.

Here, the reflectance (R₁) at the surface of the first member 11 is set to 8.16%.

The heating intensity (Pₕₑₐₜ) in the multimode case is given by the following Equation 3.

[symbol]

[Equation 3]

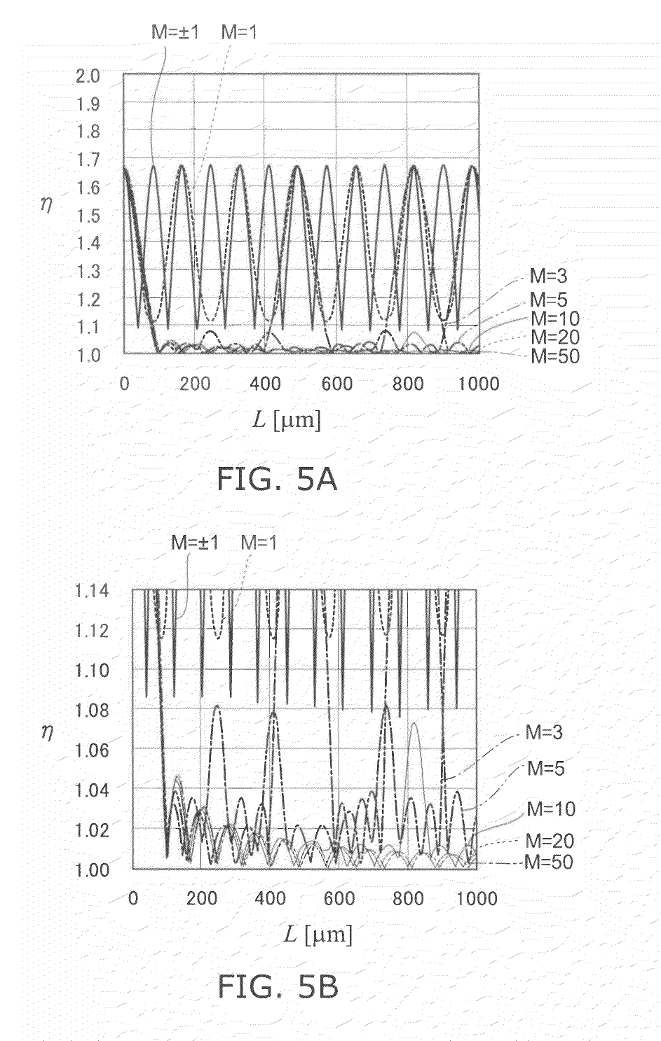

FIGS. 5A and 5B illustrate calculation results of the contrast ratio due to interference in the multimode case.

More specifically, FIGS. 5A and 5B illustrate the case where the interface reflectance R₂ is 20%. FIG. 5B is an enlarged view of η=1.00−1.14 in FIG. 5A.

In FIGS. 5A and 5B, the horizontal axis represents the thickness L (μm) of the first member 11, and the vertical axis represents the contrast ratio η. FIGS. 5A and 5B show the contrast ratio η with the longitudinal mode range M of laser light taken as a parameter.

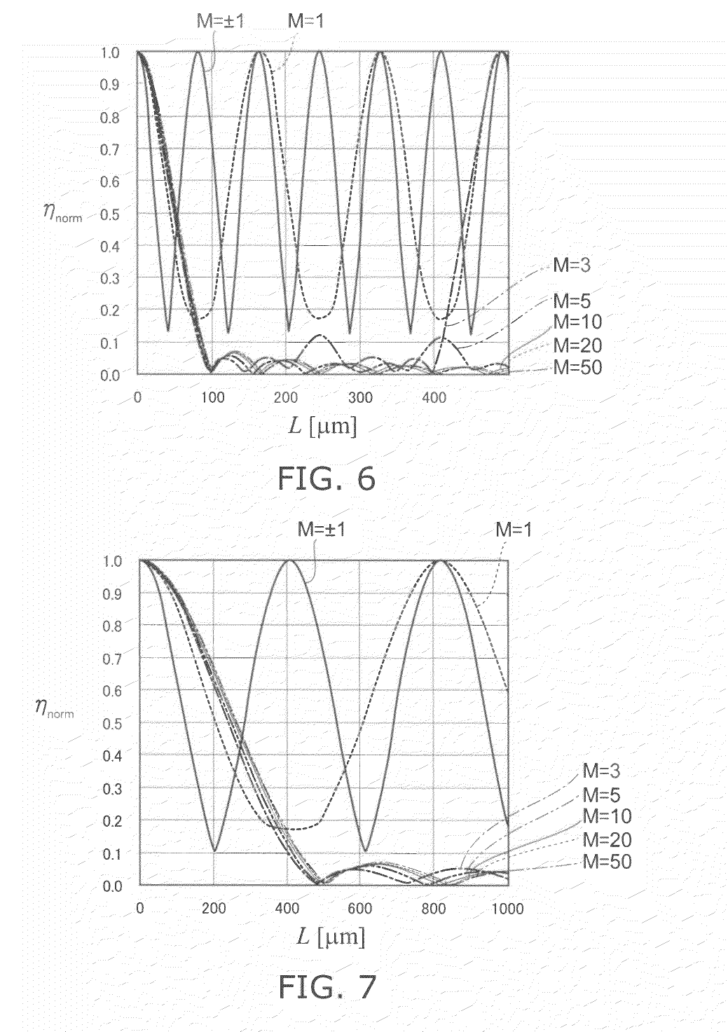

FIG. 6 shows the normalized one of the contrast ratio η shown in FIGS. 5A and 5B.

In FIG. 6, the horizontal axis represents the thickness L (μm) of the first member 11, and the vertical axis represents the normalized contrast ratio ηₙₒᵣₘ.

The normalized contrast ratio ηₙₒᵣₘ shown in FIG. 6 is obtained by normalizing the contrast ratio η(L) for the thickness L of the first member 11 by η(0), where the contrast ratio η is maximized.

Here, η(0) is given by η(0)={(1+√(R₁·R₂))/(1−√(R₁·R₂))}².

The normalized contrast ratio η(L)ₙₒᵣₘ for thickness L is given by η(L)ₙₒᵣₘ=(η(L)−1)/(η(0)−1).

That is, ηₙₒᵣₘ=1 means η={(1+√(R₁·R₂))/(1−√(R₁·R₂))}². ηₙₒᵣₘ=0 means η=1.

In FIG. 6, as an example, Nd:YVO₄ is used as a laser source. In this example, laser light with a center wavelength of 1064 nm is converted to the fourth harmonic and used as a center wavelength of 266 nm.

In FIG. 6, the gain bandwidth (λ_{w}=0.24 nm) is used as the mode span of laser light. FIG. 6 shows the normalized contrast ratio η(L)ₙₒᵣₘ with the longitudinal mode range M of laser light taken as a parameter.

Here, the number of modes for longitudinal mode range M=1 is 3. The number of modes for M=3 is 7. The number of modes for M=5 is 11. Furthermore, m=±1 represents the case of two modes (the number of mode is 2) except the center wavelength for M=1.

The gain bandwidth is the wavelength range (half-width) in which the intensity is at least half the intensity at the peak wavelength of laser light.

FIG. 7 shows an example of the normalized contrast ratio ηₙₒᵣₘ for another mode span.

FIG. 7 shows the normalized contrast ratio ηₙₒᵣₘ similar to that of FIG. 6 in the case where the mode span of light is set to ⅕ of the gain bandwidth of laser light. That is, the gain bandwidth λ_{w} in FIG. 7 is 0.24 nm×0.2=0.048 nm.

As shown in FIGS. 6 and 7, for a small number of modes, the contrast ratio η for the thickness L of the first member 11 may periodically return to the maximum. This period L_{T} of thickness L satisfies the relation given by the following Equation 4.

[symbol]

[Equation 4]

On the other hand, the relation given by the following Equation 5 is observed for the range of thickness L in which the contrast ratio η takes a value of half or more of the maximum, i.e., half width at half maximum L_{HWHM}. Here, α_{M} is a coefficient depending on the longitudinal mode range (M), the mode span (2MΔλ), and the gain bandwidth (λ_{w}). As an example, if M=3 and 2MΔλ=λ_{w}, then α_{M}≈7.4. If M=∞ and 2MΔλ=5λ_{w}, then α_{M}≈9.1.

[symbol]

[Equation 5]

In the relations given by these equations, it can also be considered that L_{T} represents the upper limit of the thickness L of the first member 11, and L_{HWHM} represents the lower limit of the thickness L of the first member 11 exhibiting the effect of suppressing the interference. Hence, the effect of suppressing the interference is superior for larger L_{T} and smaller L_{HWHM}. That is, as seen from Equations 4 and 5, a narrower mode spacing (spacing between the center wavelengths of adjacent modes) and a wider mode span are preferable.

As shown in FIGS. 6 and 7, for the thickness L of the first member 11 in practical use (e.g., 100 μm or more and 400 μm or less), and for a longitudinal mode range of M=3 or more, the effect of suppressing the interference can be sufficiently achieved if the mode span is 20% or more of the gain bandwidth (λ_{w}) and less than or equal to the gain bandwidth (λ_{w}).

### Second Embodiment

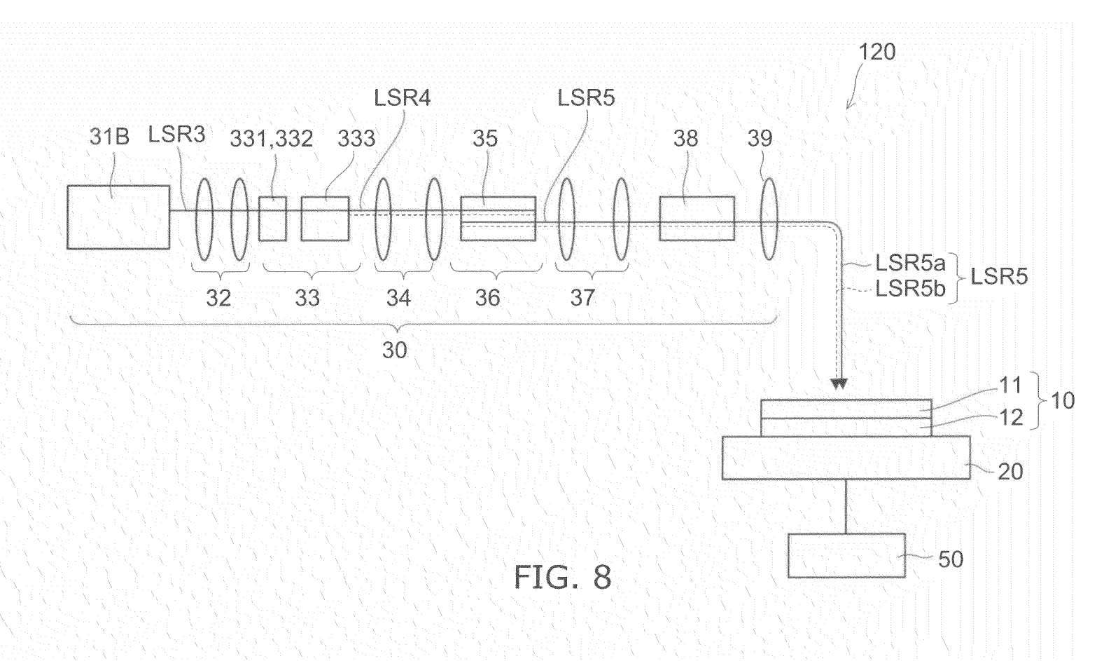

FIG. 8 is a schematic view illustrating the configuration of a member separation apparatus according to a second embodiment.

As shown in FIG. 8, the member separation apparatus 120 according to the embodiment includes a stage 20 and a light source 30. In the member separation apparatus 120, the stage 20 is the same as that of the member separation apparatus 110 shown in FIG. 1.

The light source 30 emits laser light LSR5 including laser light of a first wavelength and a second wavelength different from the first wavelength. The laser light LSR5 has a spread spectrum width by modulation of laser light LSR3 generated from the laser source 31B. The spectrum width of the laser light LSR5 includes at least first laser light LSR5a of the first wavelength and second laser light LSR5b of the second wavelength.

The modulated laser light LSR5 includes one or more spectrum distributions. The first laser light LSR5a and the second laser light LSR5b may be included in one spectrum distribution, or may be included respectively in a plurality of spectrum distributions.

The light source 30 includes a laser source 31B. The laser source 31B emits single-mode laser light LSR3. The lasing wavelength of the laser light LSR3 generated from the laser source 31B is e.g. similar to that of the laser light LSR1 generated from the laser source 31A, i.e., 200 nanometers (nm) or more and 2000 nm or less. As an example, the peak wavelength of the laser light LSR3 generated from the laser source 31B is preferably in the range of 200 nm or more and 1600 nm or less. For instance, a KrF excimer laser having a lasing wavelength of 246 nm, a YAG (yttrium aluminum garnet) laser having a lasing wavelength of 1064 nm, and a Nd:YVO₄ laser can be used.

Besides the laser source 31B, the light source 30 includes e.g. a first expander 32, a first collimator 33, a reducer 34, a second collimator 36, and a second expander 37. The first expander 32 expands the beam diameter of the laser light LSR3.

The first collimator 33 e.g. collimates the laser light LSR3 having the expanded beam diameter. The first collimator 33 includes e.g. an attenuator 331 and a wave plate 332. Furthermore, the first collimator 33 includes a modulator 333. The modulator 333 modulates the laser light LSR3 in response to a prescribed electrical signal to emit laser light LSR4 in which the spectrum width of the laser light LSR3 is spread. The spectrum distribution of the laser light LSR4 is e.g. a distribution having the same center wavelength as the laser light LSR3 and a wider spectrum width than the laser light LSR3. Alternatively, the spectrum distribution of the laser light LSR4 may include distributions respectively on both sides of the center wavelength of the laser light LSR3.

The reducer 34 reduces the beam diameter of the laser light LSR4 modulated in the modulator 333. The second collimator 36 e.g. collimates the laser light LSR4 having the reduced beam diameter. The second collimator 36 is provided with a wavelength conversion element 35 as necessary. The wavelength conversion element 35 converts the wavelength of the laser light LSR4 modulated in the modulator 333 to generate laser light LSR5 including a component of the first wavelength and a component of the second wavelength.

The second expander 37 expands the beam diameter of the laser light LSR5 wavelength-converted in the wavelength conversion element 35.

The member separation apparatus 120 according to the embodiment may include a controller 50 for controlling the relative position of the workpiece 10 mounted on the stage 20 and the irradiation position of the laser light LSR5.

In the member separation apparatus 120, the laser light LSR3 is fast-modulated by the modulator 333. This is equivalent to lasing of multimode laser light having an infinitely small mode spacing.

The laser light components with different peak wavelengths form different interference patterns in the same first member 11. Hence, by superposing the interference patterns resulting from laser light components having a plurality of peak wavelengths, the magnitude of the interference pattern is decreased. This suppresses heating nonuniformity of the workpiece 10 due to the interference pattern.

Here, in the member separation apparatus 120, preferably, the center wavelength of the laser light LSR3 generated from the laser source 31B is set to a long wavelength, and the laser light LSR3 is converted to a higher harmonic (N-th harmonic) for use. In the case of using the N-th harmonic, modulation is performed before conversion to the N-th harmonic. Thus, when modulation is performed, the required modulation rate (modulation frequency) is advantageously reduced to 1/N.

In the example of the member separation apparatus 120 described above, the single-mode laser light LSR3 is modulated. However, it is also possible to modulate multimode laser light. That is, the first embodiment may be combined with the second embodiment. In this case, the laser source 31B is replaced by the laser source 31A. The multimode laser light is modulated in the modulator 333.

### Third Embodiment

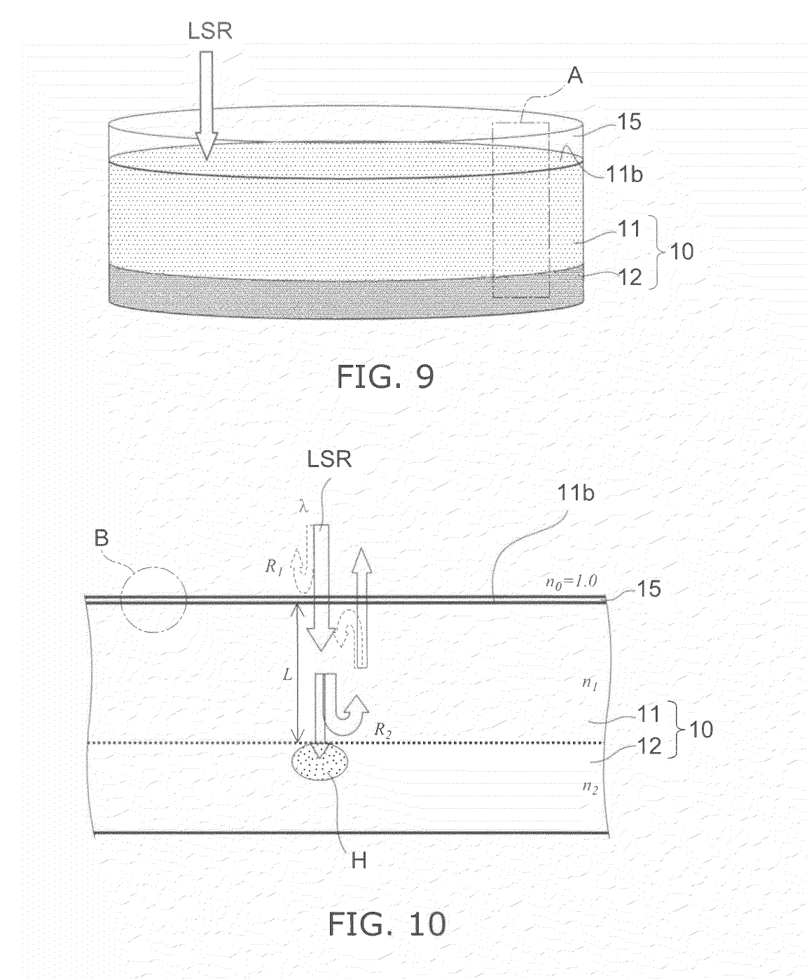

FIG. 9 is a schematic perspective view describing a member separation method according to a third embodiment.

FIG. 10 is a schematic sectional view describing the member separation method according to the third embodiment.

FIG. 10 illustrates transmission and reflection of laser light in portion A shown in FIG. 9.

More specifically, the member separation method according to the third embodiment is a method for generating laser light having a peak at a first wavelength, applying the laser light to a workpiece 10, and separating a first member 11 and a second member 12 from each other.

In the step of applying the laser light, an optical film 15 is provided on the second major surface 11b of the first member 11 of the workpiece 10, and the laser light is applied through this optical film 15.

The optical film 15 is e.g. a reflection suppressing film for suppressing reflection of laser light LSR inside the first member 11. Here, the optical film 15 may be any layer for suppressing reflection of laser light LSR. For instance, the optical film 15 may include a plurality of unevennesses (protrusions or depressions).

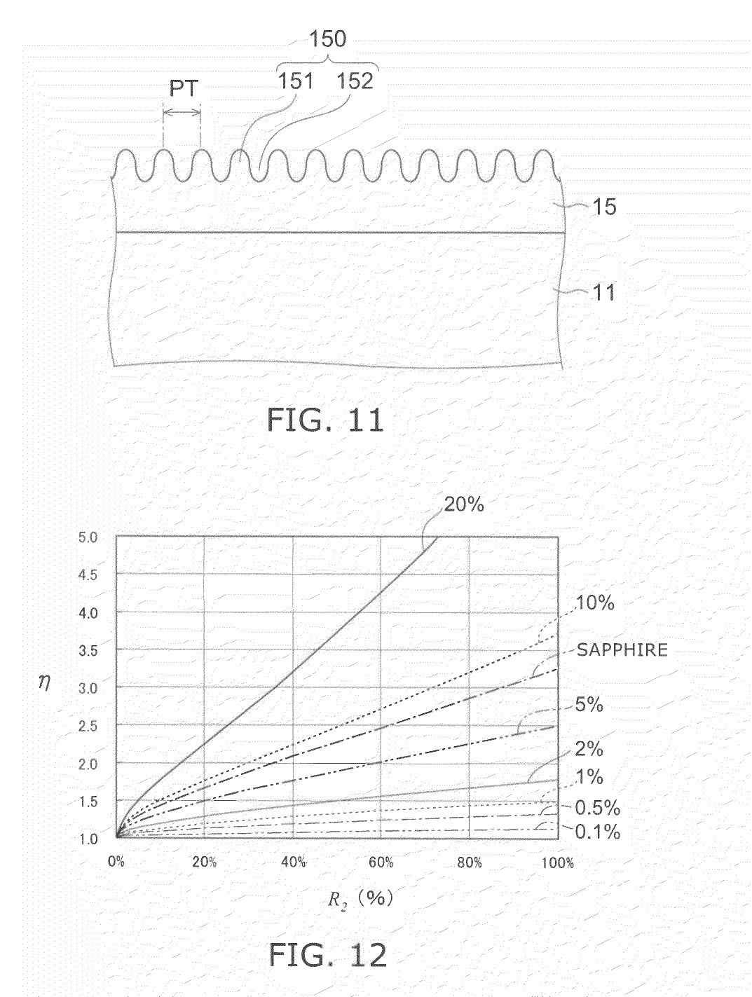

FIG. 11 is a schematic sectional view illustrating an uneven portion.

More specifically, FIG. 11 schematically shows a cross section in which portion B shown in FIG. 10 is enlarged.

As shown in FIG. 11, the optical film 15 includes an uneven portion 150 including continuous protrusions 151 and depressions 152. For instance, the pitch PT between two adjacent unevennesses (protrusions 151 or depressions 152) is smaller than the peak wavelength (first wavelength) of laser light LSR. For instance, the pitch PT is smaller than half the peak wavelength (first wavelength) of laser light LSR. The optical film 15 including such an uneven portion 150 can suppress the reflectance for laser light LSR.

Here, the uneven portion 150 may be provided integrally with the first member 11 at the second major surface 11b of the first member 11.

FIG. 12 shows a calculation example of the relationship between the interface reflectance and the contrast ratio of laser light.

In FIG. 12, the horizontal axis represents the interface reflectance (R₂),and the vertical axis represents the contrast ratio η. In FIG. 12, the contrast ratio η for the interface reflectance (R₂) is calculated using Equation 2 with the reflectance (R₁) of the optical film 15 taken as a parameter.

The interface reflectance (R₂) ranges from 0% to 99%. The reflectance (R₁) of the optical film 15 ranges over 20%, 10%, 5%, 2%, 1%, 0.5%, and 0.1%.

For reference, a calculation result with the reflectance of the surface of sapphire (8.16%) taken as a parameter is also shown.

As shown in FIG. 12, the contrast ratio η for the reflectance of the surface of sapphire (8.16%) is significantly affected by the interface reflectance (R₂). For instance, when the interface reflectance (R₂) is 20%, the contrast ratio η is approximately 1.67. When the interface reflectance (R₂) exceeds approximately 36%, the contrast ratio η becomes 2 or more.

Here, if an optical film 15 with a reflectance (R₁) of 0.1% is formed, then for an interface reflectance (R₂) of 20%, the contrast ratio η is suppressed to approximately 1.07. For an interface reflectance (R₂) of 90%, the contrast ratio η is suppressed to approximately 1.13.

For instance, consider an optical film 15 made of a dielectric (e.g., silicon oxide) having a refractive index between the refractive index (n₀) for laser light LSR of the first member 11 and the refractive index (n₁) for laser light LSR of the medium (e.g., air) on the laser light LSR incident side of the first member 11. The optical film 15 is formed with a thickness of e.g. approximately 45 nm by e.g. sputtering film formation. Then, the reflectance (R₁) is approximately 1%. Thus, for an interface reflectance (R₂) of 20%, the contrast ratio η can be suppressed to approximately 1.21.

Thus, by providing the optical film 15 on the first member 11, the magnitude of interference of laser light LSR in the first member 11 can be suppressed. This suppresses heating irregularities of the workpiece 10 due to the interference pattern. Thus, by irradiation with laser light LSR, the first member 11 and the second member 12 can be reliably separated from each other.

Such an optical film 15 for suppressing the interference of laser light LSR is provided on the first member 11 of the workpiece 10. Hence, to the workpiece 10 including the first member 11 provided with the optical film 15, the member separation method according to the embodiment is applicable.

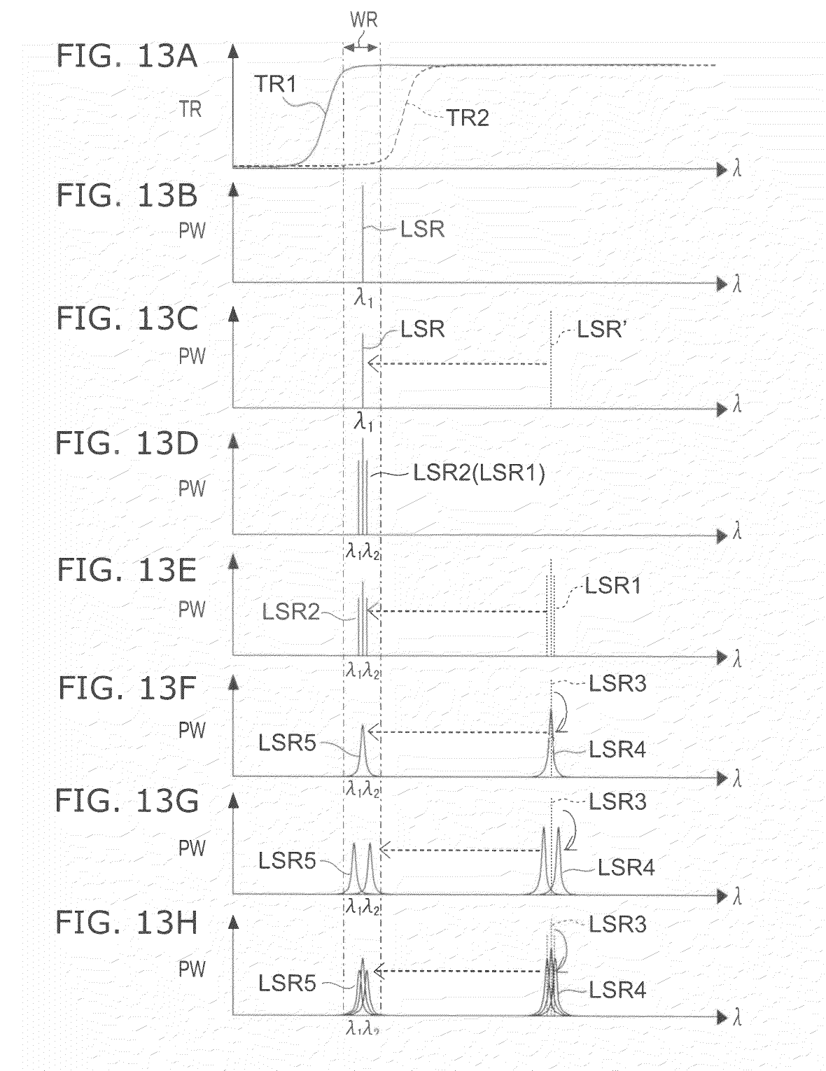

FIGS. 13A to 13H are schematic views illustrating the wavelength of laser light applied in each embodiment described above.

FIG. 13A shows the light transmittance TR for wavelength λ of the first member 11 and the second member 12.

FIGS. 13B to 13H show the intensity PW of laser light for wavelength λ.

As shown in FIG. 13A, in the wavelength region WR including the first wavelength λ₁, the light transmittance TR1 of the first member 11 is higher than the light transmittance TR2 of the second member 12. That is, in the wavelength region WR, the light absorptance of the second member 12 is higher than the light absorptance of the first member 11.

FIGS. 13B and 13C show the wavelength of laser light according to a reference example.

In the example shown in FIG. 13B, single-mode laser light LSR having a peak at the first wavelength λ₁ is used as light applied to the workpiece 10.

In the example shown in FIG. 13C, single-mode laser light LSR′ having a peak at a wavelength different from the first wavelength λ₁ is wavelength-converted to generate laser light LSR having a peak at the first wavelength λ₁. This laser light LSR is applied to the workpiece 10.

In the examples using laser light LSR shown in FIGS. 13B and 13C, as shown in FIGS. 3A and 3B, variation of light intensity due to interference of laser light LSR appears at the boundary surface 12a.

FIGS. 13D and 13E show the wavelength of laser light corresponding to the first embodiment.

In the example shown in FIG. 13D, multimode laser light LSR2 having peaks at the first wavelength λ₁ and the second wavelength λ₂ is applied to the workpiece 10. The laser light LSR2 is included in the wavelength region WR. In this example, wavelength conversion is not used. Hence, the wavelength of laser light LSR1 generated from the laser source 31A is equal to that of the laser light LSR2 applied to the workpiece 10.

In the example shown in FIG. 13E, laser light LSR1 generated from the laser source 31A is wavelength-converted to generate laser light LSR2 having peaks at the first wavelength λ₁ and the second wavelength λ₂. This laser light LSR2 is applied to the workpiece 10. The laser light LSR2 is included in the wavelength region WR.

In the examples using laser light LSR2 shown in FIGS. 13D and 13E, as shown in FIGS. 4A and 4B, the laser light LSR2 includes laser light components of the first wavelength λ₁ and the second wavelength λ₂. Variations of interferences at the boundary surface 12a resulting from these laser light components cancel out each other. This suppresses nonuniform heating. Thus, the first member 11 and the second member 12 can be reliably separated from each other.

FIGS. 13F to 13H show the wavelength of laser light corresponding to the second embodiment.

In the example shown in FIG. 13F, single-mode laser light LSR3 generated from the laser source 31B is modulated to generate laser light LSR4 having a spread spectrum width. By wavelength conversion, laser light LSR5 including the first wavelength λ₁ and the second wavelength λ₂ is generated. This laser light LSR5 is applied to the workpiece 10. The laser light LSR5 is included in the wavelength region WR.

In the example shown in FIG. 13G, single-mode laser light LSR3 generated from the laser source 31B is modulated to spread the spectrum width to generate laser light LSR4 including two distributions. By wavelength conversion, laser light LSR5 including the first wavelength λ₁ and the second wavelength λ₂ is generated. This laser light LSR5 is applied to the workpiece 10. The laser light LSR5 is included in the wavelength region WR. The first wavelength λ₁ and the second wavelength λ₂ are included in the respective distributions of the laser light LSR5.

In the example shown in FIG. 13H, multimode laser light LSR3 generated from the laser source 31B is modulated to generate laser light LSR4 having a spread spectrum width. By wavelength conversion, laser light LSR5 including the first wavelength λ₁ and the second wavelength λ₂ is generated. This laser light LSR5 is applied to the workpiece 10. The laser light LSR5 is included in the wavelength region WR.

In the examples using laser light LSR5 shown in FIGS. 13F to 13H, like the laser light LSR2 shown in FIGS. 4A and 4B, the laser light LSR5 includes laser light components of the first wavelength λ₁ and the second wavelength λ₂. Variations of interferences at the boundary surface 12a resulting from these laser light components cancel out each other. This suppresses nonuniform heating. Thus, the first member 11 and the second member 12 can be reliably separated from each other.

As described above, the embodiments can provide a member separation apparatus and a member separation method capable of separating members with high productivity to manufacture a high quality product.

The embodiments and the variations thereof have been described above. However, the invention is not limited to these examples. For instance, those skilled in the art can modify the above embodiments or the variations thereof by suitable addition, deletion, and design change of components, and by suitable combination of the features of the embodiments. Such modifications are also encompassed within the scope of the invention as long as they fall within the spirit of the invention.

For instance, the first member 11 can be made of a material other than sapphire. The second member 12 can be other than the semiconductor stacked body.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A member separation apparatus comprising:
a stage to mount a workpiece including a first member and a second member being in contact with the first member, the first member being transmissive to light in a wavelength region including a first wavelength, and the second member having a higher absorptance for light in the wavelength region than the first member; and
a light source to generate laser light in the wavelength region and to irradiate the workpiece with the laser light, the laser light containing a component of the first wavelength and a component of a second wavelength included in the wavelength region and being different from the first wavelength.

2. The apparatus according to claim 1, wherein the light source comprising:
a laser source to generate such laser light that includes a plurality of wavelengths lased in a plurality of longitudinal modes; and
a wavelength conversion member to convert the wavelengths of the laser light generated from the laser source to contain the component of the first wavelength and the component of the second wavelength.

3. The apparatus according to claim 1, wherein the light source comprising:
a laser source;
a modulator to modulate laser light generated from the laser source to spread spectrum width; and
a wavelength conversion member to convert the wavelength of the laser light modulated in the modulator and having the spread spectrum width to generate the component of the first wavelength and the component of the second wavelength.

4. The apparatus according to claim 2, wherein the laser source is a laser light source to generated the laser light having a lasing wavelength of not less than 200 nanometers and not more than 2000 nanometers.

5. The apparatus according to claim 3, wherein the laser source is a laser light source to generated the laser light having a lasing wavelength of not less than 200 nanometers and not more than 2000 nanometers.

6. The apparatus according to claim 1, further comprising:
a controller to control relative position of the workpiece mounted on the stage and irradiation position of the laser light.

7. The apparatus according to claim 2, wherein the wavelength conversion member multiplies center wavelength of light generated from the laser source by 1/n (n being an integer of 2 or more).

8. The apparatus according to claim 3, wherein the wavelength conversion member multiplies center wavelength of light generated from the laser source by 1/n (n being an integer of 2 or more).

9. A member separation method comprising:
generating laser light including a component of a first wavelength and a component of a second wavelength different from the first wavelength; and
irradiating a workpiece including a first member and a second member with the laser light to separate the first member from the second member, the first member being transmissive to the laser light, and the second member being in contact with the first member and having an absorptance, the absorptance for light of the first wavelength being higher than the absorptance for light of the second wavelength.

10. The method according to claim 9, wherein the generating laser light includes:
generating multimode laser light including a plurality of wavelengths; and
converting the wavelengths of the multimode laser light to generate the component of the first wavelength and the component of the second wavelength.

11. The method according to claim 9, wherein the laser light is single-mode laser light.

12. The method according to claim 9, wherein the generating laser light includes:
modulating laser light generated from a laser source to spread spectrum width; and
converting wavelength of the laser light having the spread spectrum width to generate the component of the first wavelength and the component of the second wavelength.

13. The method according to claim 12, wherein the modulating laser light generated from the laser source to spread spectrum width includes varying the wavelength of the laser light with time.

14. The method according to claim 9, wherein wavelength band of the laser light is not less than 20% of gain bandwidth of the laser light and not more than the gain bandwidth.

15. The method according to claim 9, wherein
the first member is provided with an optical film, and
the optical film includes a film having a refractive index between refractive index for the laser light of the first member and refractive index for the laser light of a medium on the laser light incident side of the first member.

16. The method according to claim 15, wherein the optical film includes a dielectric.

17. The method according to claim 15, wherein the optical film includes a conductor.

18. A member separation method comprising:
generating laser light including a component of a first wavelength; and
irradiating a workpiece including a first member and a second member with the laser light through an optical film to separate the first member from the second member, the first member being transmissive to light of the first wavelength, the second member being in contact with the first member and having a higher absorptance for the light of the first wavelength than the first member, and the optical film being provided on an opposite surface of the first member from the second member and suppressing reflection of the laser light in the first member.

19. The method according to claim 18, wherein the optical film includes a plurality of unevennesses having a pitch smaller than half of wavelength of the laser light.

20. The method according to claim 18, wherein the optical film is a reflection suppressing film to suppress reflection of the laser light inside the first member.
